(19) United States
(12) Patent Application Publication
(10) Pub. No.: US 2014/0007005 A1
(43) Pub. Date: Jan. 2, 2014

(54) SCROLLABLE CALENDAR WITH COMBINED DATE AND TIME CONTROLS

(71) Applicant: EVERNOTE CORPORATION, Redwood City, CA (US)

(72) Inventors: Phil Libin, San Jose, CA (US); Naomi Pilosof, San Francisco, CA (US); Carlos Rocafort, IV, Mountain View, CA (US); Juan Gabriel Arzola-Rodriguez, Mountain View, CA (US)

(73) Assignee: Evernote Corporation, Redwood City, CA (US)

(21) Appl. No.: 13/872,333

(22) Filed: Apr. 29, 2013

Related U.S. Application Data
(60) Provisional application No. 61/666,363, filed on Jun. 29, 2012.

(51) Int. Cl. G06F 3/0485

(52) U.S. Cl. CPC G06F 3/0485
USPC 715/784

(57) ABSTRACT

Electronically selecting a date and time includes scrolling a series of panels, each panel corresponding to a number of days grouped together, where visually the panels appear to be rotating about a first axis coplanar with a screen of an electronic device, selecting at least one of the panels, selecting a day on one of the panels, scrolling a time band having positions thereon corresponding to a time of day, where visually the time band appear to be rotating about a second axis coplanar with a screen of the electronic device, and selecting a position on the time band corresponding to a particular time by stopping the time band from rotating. Each panel may correspond to a month. Each panel may include a banner having visual clues indicating a corresponding month. The time band may include visual clues indicating time of day.

### CROSS-REFERENCE TO RELATED APPLICATIONS

This application claims priority to U.S. Prov. App. No. 61/666,363, filed Jun. 29, 2012, and entitled “SCROLLABLE CALENDAR WITH COMBINED DATE AND TIME SETTINGS AND VIEWS”, which is incorporated herein by reference.

### TECHNICAL FIELD

This application is directed to the field of information presentation and user interface, particularly in connection with personal information management and scheduling.

### BACKGROUND OF THE INVENTION

In 2012, the number of connected mobile devices in use, including mobile phones and tablets, has exceed, for the first time, the population of our planet. Market forecasts indicate that, by 2016, there will be over 10 billion of Internet-connected mobile devices in the hands of end users, of which approximately eight billion will be smartphones and tablets. Accordingly, an everyday productivity and convenience of billions of people will become increasingly dependent on the efficiency of their use of mobile applications.

Touchscreen navigation and operation of mobile devices has become a mainstream method of control of the mobile productivity software. Haptic control and visual appearance are two efficiency aspects for modern applications running on smartphones and tablets. The tap/drag/pinch/swipe gestures for selection, scrolling and zooming are ubiquitous on multi-touch screens, irrespective of hardware specifics and operating system; these single- and multi-touch gestures are used billions of times a day within many thousands of touch enabled mobile applications. In order to make these gestures convenient for an everyday use within a mobile application, the size and position of UI (User Interface) elements such as buttons, scrollable elements, resizable panes, should be selected to make it easy for users with different finger sizes and reaction speeds to operate the elements. Minimization of unnecessary hand movements within the application workflow is often a significant design requirement for applications. At the same time, touch enabled applications are expected to provide a sufficient movement diversity to helps avoid RSI (Repetitive Stress Injuries) and other disorders caused by monotonous muscular work. Visual appeal of a mobile application and a non-invasive pictorial assistance provided by imagery of the application are maintained while retaining an overall persistence of the UI of an application.

One widespread type of the mobile software, also ubiquitous on desktop and on the web, is a day/time picker, which facilitates date & time entry into calendars, other scheduling applications, forms, and application fields, such as a meal date in the Evernote Food application, developed by Evernote Corporation of Redwood City, Calif. Date and time pickers replace an error-prone process of manual typing of date/time values and offer a keyboard-free selection based on a graphical UI. The two most popular types of date and time pickers are the calendar style and the wheel scroller style designs.

Calendar style pickers, such as used in the Microsoft Outlook or Silverlight, may display a month calendar grid for date selection; the grid view may be supplemented with a round clock face for setting the time; entering the time into a HH:MM or a HH:MM:SS field below the clock may be another option. Months may be switched by the horizontal scrolling arrows, which may be located in the upper corners of the month grid; time field may allow selection, manual typing and scrolling via similar small scrolling arrows.

Wheel scroller style pickers used in mobile applications for Apple iOS, Google Android and other operating systems may have a separate and independently operated touch enabled scrollbar for each of the date and time components, including day, month, year, hour, and minute; there may be another scrollbar or button for the morning/afternoon (am/pm) choice. Such date and time pickers are operated analogously to multiple-dial locks where each component of date/time format is independently scrolled to reach the desired position.

It should be noted that calendar style pickers are difficult to use with multi-touch gestures because of small navigational elements (arrows) for switching month and time values and the necessity to periodically select small text entries within the time field. This type of date/time picker is optimized rather for the desktop and mouse operation than for multi-touch screens. On the other hand, wheel scroller design is well suited for one-finger operation on mobile touch screens; however, conventional wheel scrollers lack a visual consistency and convenience of the calendar view. Additionally, a conventional wheel scroller doesn't have weekday info and requires multiple mechanistic and monotonous operations to set date and time, lacking a clear visual feedback and therefore provoking higher error rates and the need for corrections.

Accordingly, it is desirable to develop date and time pickers for mobile applications that combine easy and fast multi-touch operation with visual appeal of traditional calendar views.

### SUMMARY OF THE INVENTION

According to the system described herein, electronically selecting a date and time includes scrolling a series of panels, each panel corresponding to a number of days grouped together, where visually the panels appear to be rotating about a first axis coplanar with a screen of an electronic device, selecting at least one of the panels, selecting a day on one of the panels, scrolling a time band having positions thereon corresponding to a time of day, where visually the time band appear to be rotating about a second axis coplanar with a screen of the electronic device, and selecting a position on the time band corresponding to a particular time by stopping the time band from rotating. Each panel may correspond to a month. Each panel may include a banner having visual clues indicating a corresponding month. The time band may include visual clues indicating time of day. Selecting a position of the time band corresponding to a particular time may include providing a stationary indicator that points to the particular time. The first and second axes may be substantially orthogonal. The first axis extends substantially left to right with respect to a user viewing the screen of the electronic device and the second axis extends substantially up and down with respect to a user viewing the screen of the electronic device. Selecting at least one of the panels may include stopping the series of panels from rotating. Following stopping the series of panels, a single panel may be presented on the screen. Following stopping the series of panels, an end portion of one panel and a beginning portion of a subsequent panel may be presented on the screen. Scrolling the series of panels may include using a swiping gesture in a direction substantially orthogonal to the first axis of rotation, where a speed of rotation of the first series of panels varies according to a speed of the swiping gesture. Following the swiping gesture, rotation of the series of panels may decelerate and, at the end of the deceleration, rotation may momentarily accelerate to statically present a single one of the panels on the screen. The electronic device may be a tablet and/or a mobile phone.

According further to the system described herein, computer software, provided in a non-transitory computer-readable medium, facilitates electronically selecting a date and time. The software includes executable code that, in response to user input, scrolls a series of panels, each panel corresponding to a number of days grouped together, where visually the panels appear to be rotating about a first axis coplanar with a screen of an electronic device, executable code that, in response to user input, scrolls a time band having positions thereon corresponding to a time of day, wherein visually the time band appear to be rotating about a second axis coplanar with a screen of the electronic device, and executable code that accepts a user selection of a date corresponding to the series of panels and a time corresponding to a position on the time band. Each panel may correspond to a month. Each panel may include a banner having visual clues indicating a corresponding month. The time band may include visual clues indicating time of day. A stationary indicator may be provided that points to the particular time selected by the user. The first and second axes may be substantially orthogonal. The first axis extends substantially left to right with respect to a user viewing the screen of the electronic device and the second axis extends substantially left to right with respect to a user viewing the screen of the electronic device. The electronic device may be a tablet and/or a mobile phone.

The proposed system allows setting the date and time by one-finger scrolling and tapping within two panes, simultaneously rendered on the screen of mobile device: a date picker pane, and a time picker pane. Both panes are scrollable with inertia in two orthogonal directions. Visual clues accompany both the month and the time selection to facilitate the process and reduce the error rate.

The date picker pane is a contiguous vertically scrollable band of monthly grids (panels) that may show at one time one full monthly calendar. However, portions of two adjacent monthly grids may also be displayed in the time picker pane, which allows for the date selection from any of the two portions of neighboring months; for example, each of the dates Mar. 18, 2012 and Apr. 5, 2012 may be selected on the same screen from two adjacent and partially visible monthly grids. Scrolling with inertia allows quick access to different months and years, so the date selection process is relatively fast and has the advantageous weekly look of a conventional calendar. An additional feature facilitating the choice of a necessary date is an automatic snapping of monthly grids. The system tracks scrolling speed for the monthly grid and when scrolling slows down, the system estimates a stopping position of the grid. If the stopping position corresponds to a particular month occupying a sufficient portion of the grid, the system automatically snaps the banner of the particular month to a top position of the grid and displays a one-month view of the grid. If, in contrast, in the stopping position each of two adjacent months occupy a sufficient portion of the grid, then a two-month view is left intact.

The time picker pane has an endless time band covering a 24-hour day and is visually split into four daytime periods, as explained elsewhere herein. The time band is also scrollable with inertia; hours and minutes appear under a needle and stopping the band after some scrolling causes the choice of the time value under the needle. In different embodiments, time values for conventional scheduling tasks may be scrolled with a 30-minute, a 15-minute or other interval.

Upon opening on a mobile device, the date and time picker displays, by default, the current date and time, provided by the device's system clock. Subsequently, a date and time choice takes a maximum of three quick multi-touch operations: (1) scrolling a monthly grid to get the needed month (this optional part may be omitted if the date is chosen within the current month); (2) tapping on a needed day within the month; and (3) scrolling and stopping the time picker so a needed hour/minute value appears under the needle. Compared with traditional calendar or wheel scroller designs, the proposed system saves a significant number of taps and scrolls for each date/time selection operation. Scrolling with considerable inertia additionally accelerates the date/time choice. For example, a full-speed swipe gesture in the date selection pane (using any number of fingers recognized by the device's touch screen) rolls the month band by 6-7 months in the direction of swipe, which may be sufficient, in many practical scheduling applications, to obtain a desired month. In one embodiment, a one-finger swipe is the fastest method. Similarly, a maximum impulse swipe gesture of the time band takes the user through the whole day within approximately two seconds. Stopping the time band midway by touching the screen instantly brings the time picker close to the desired time selection.

In addition to fast scrolling and selection capabilities, the proposed system employs a series of visual clues to further facilitate the date and time picking process, reduce the error rate and increase an aesthetic appeal of the UI. Thus, different months may appear under top banners illustrating seasonal and month specific themes and helping users to quickly assess a choice-or-scroll action. In a similar manner, the time band may be split into four day periods (or another number of periods): morning, afternoon, evening, and night, delimited by small images indicating the daytimes, such as icons of sunrise, afternoon sun, half-moon, and stars. Visual daytime clues may be further amplified by variable brightness of the time band (maximum brightness at noon and minimum brightness at midnight). An additional visual assistance for an accurate time pick provided by the above-described features may eliminates a need for an am/pm scale or switch.

The proposed system may be further customized to reflect user specific conditions and provide an even higher level of accuracy for the date and time picking process. For example, the imagery in the date picker pane may be adapted for international users to display culturally acceptable illustrations of months and day/night times. The structure of the time band may also be dynamically adapted based on the system clock and the knowledge of the current date, in order to shorten/lengthen daytime and nighttime portions of the time band, depending on the factual day length; the system may also display realistic depictions of the moon phases.

### BRIEF DESCRIPTION OF THE DRAWINGS

Embodiments of the system described herein will now be explained in more detail in accordance with the figures of the drawings, which are briefly described as follows.

FIG. 1 is a schematic illustration of a general view of the proposed system according to an embodiment of the system described herein.

FIGS. 2A-2C schematically illustrate operation of the date picker according to an embodiment of the system described herein.

FIGS. 3A-3B are schematic illustrations of snapping of a monthly grid to display a one-month view according to an embodiment of the system described herein.

FIG. 4 is a schematic illustration of monthly banners with visual clues according to an embodiment of the system described herein.

FIG. 5 schematically illustrates operating the time picker according to an embodiment of the system described herein.

FIG. 6 is a schematic illustration of a four daytime portions of the time picker with visual clues according to an embodiment of the system described herein.

FIG. 7 is a system flow diagram describing operation of the date picker according to an embodiment of the system described herein.

FIG. 8 is a system flow diagram describing operation of the time picker according to an embodiment of the system described herein.

### DETAILED DESCRIPTION OF VARIOUS EMBODIMENTS

The system described herein provides a method for fast setting of date and time on touch enabled devices via scrollable date and time picker with two simultaneously rendered panes. The system uses a minimal number of gestures: swiping, scrolling and tapping and requires a maximum of three quick operations to set up date and time. It provides additional visual clues and customizations to simplify the process of date and time selection and make it aesthetically attractive.

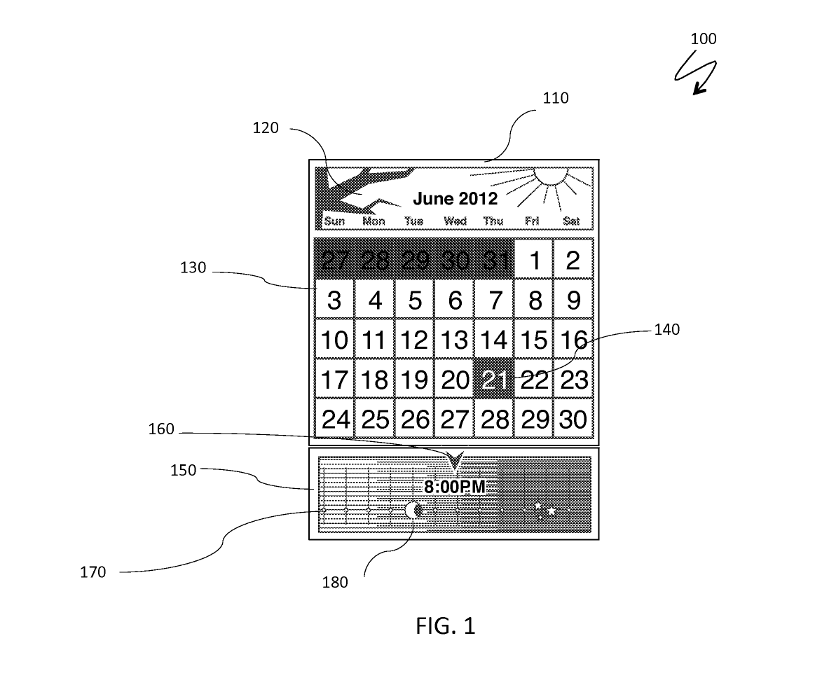

FIG. 1 is a schematic illustration 100 of a general view of the proposed system. In an embodiment, a date picker 110 includes a monthly banner 120 and a monthly grid 130. The monthly grid 130 is a panel that shows days of the month. Note that, in other embodiments, the panel 130 could show different groups of days, such as N days, a single week, two weeks together, two months together, etc. The date picker 110 may also include portions of two adjacent monthly grids, as explained elsewhere herein. Operating a date picker 110 results in a selected date 140. Another part of the proposed system is a time picker 150 with a needle 160, which indicates a selected time, displayed on an illustration 120 below the needle 160. The time picker 150 also includes a time band 170 and daytime separators 180. As shown on FIG. 1, the time band 150 is displayed with different degrees of shading which provide another set of visual clues for the daytime, in addition to the daytime separators.

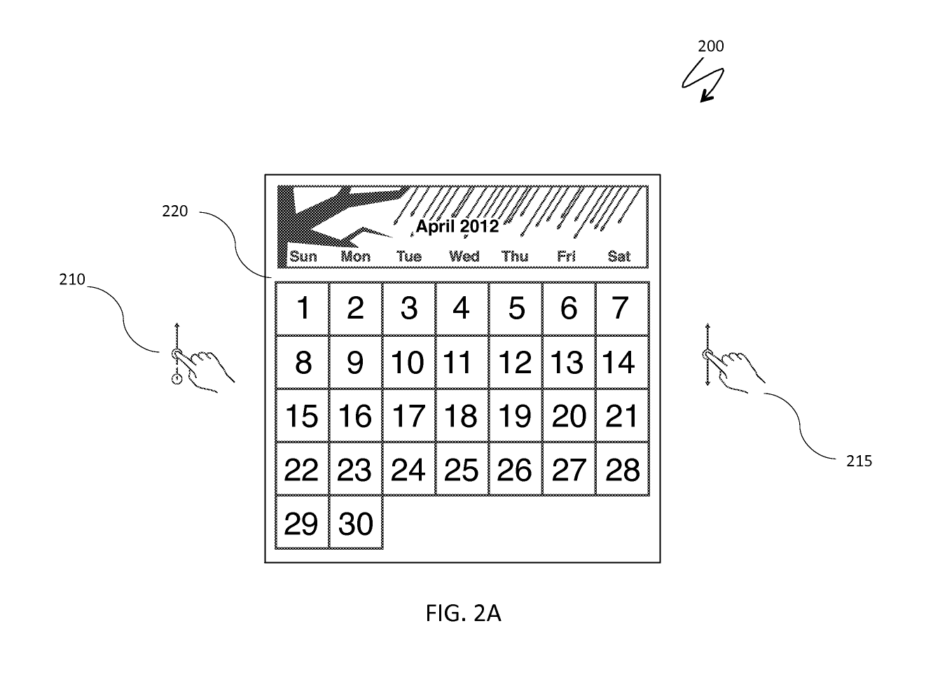

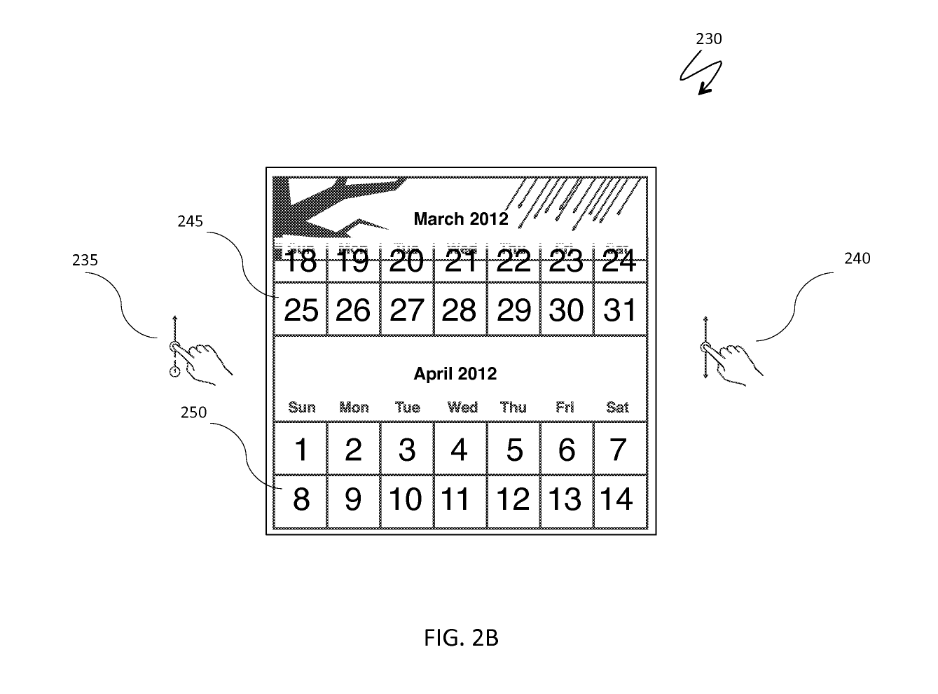

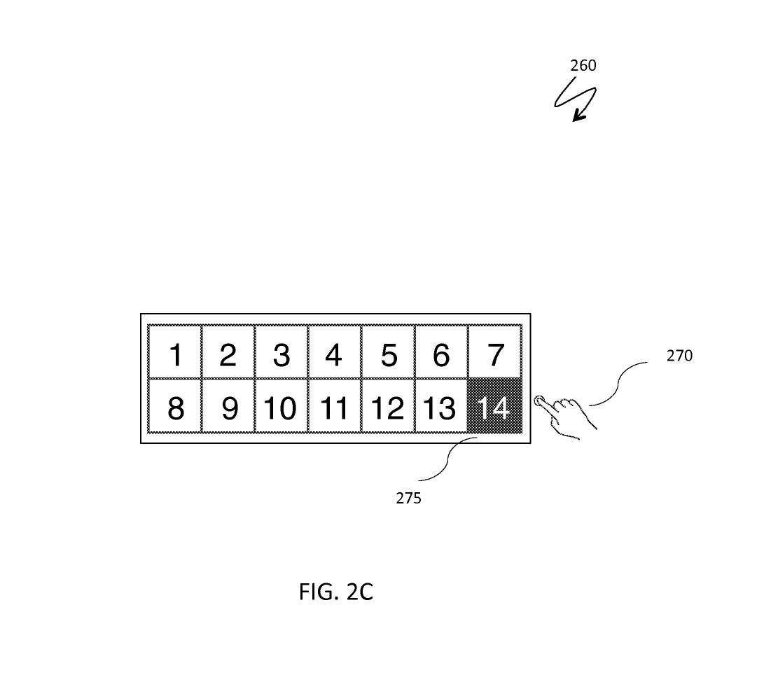

FIG. 2A is a schematic illustration 200 of a basic touch operation of a date picker 220. The illustration 200 shows two touch operations: a swiping gesture 210 and a scrolling gesture 215, respectively, for fast scrolling with inertia and slow controlled scrolling of the date picker 220. It should be noted that both pictograms used to illustrate the gestures 210, 215 show one-finger operations. However, swipe and scroll gestures with any number of fingers that is supported by the operating system of a mobile device may be detected and used to provide the functionality described herein. Scrolling speed with a swiping gesture depends on a speed of a brief swipe gesture measured by a touch system of the device and transmitted to the proposed system. After the swiping gesture is performed, the system rolls the date picker 220 in a swipe direction and then decelerates the date picker 220 according to the inertia parameters. In an embodiment herein, with a maximum swipe speed allowed by the system, the monthly grid progresses by six to seven full months within several seconds, displaying scrolling progress during rotation. A user may wait until the swipe related scrolling stops, either due to deceleration or because the grid reaches the last month on a scale; alternatively, the user may intercept the fast scrolling by touching the screen and moving the grid in any direction without lifting any finger(s). The user may use the latter technique when a desired month appears on the screen during fast scrolling. In such a case, brief controlled scrolling or an instant halt to the scrolling may display the desired month and allow the user to pick a needed date.

FIG. 2B is a schematic illustration 230 of an alternative disposition of operation of the monthly grid where a combination of a swipe gesture 235 and a scroll gesture 240 leave the date picker displaying two adjacent monthly grids 245, 250 for fast picking of a desired date before the month 250 has fully occupied the grid or before the month 245 has left the grid during fast scrolling.

FIG. 2C is a schematic illustration 260 of a final step of operating of the date picker. Once the grid stops scrolling (either after free fast scrolling initiated by a swipe gesture or explicitly stopped by a user in the scrolling mode) and displays one or more desired months and range of dates, a user taps 270 directly on a desired date cell 275 to instantly pick a date.

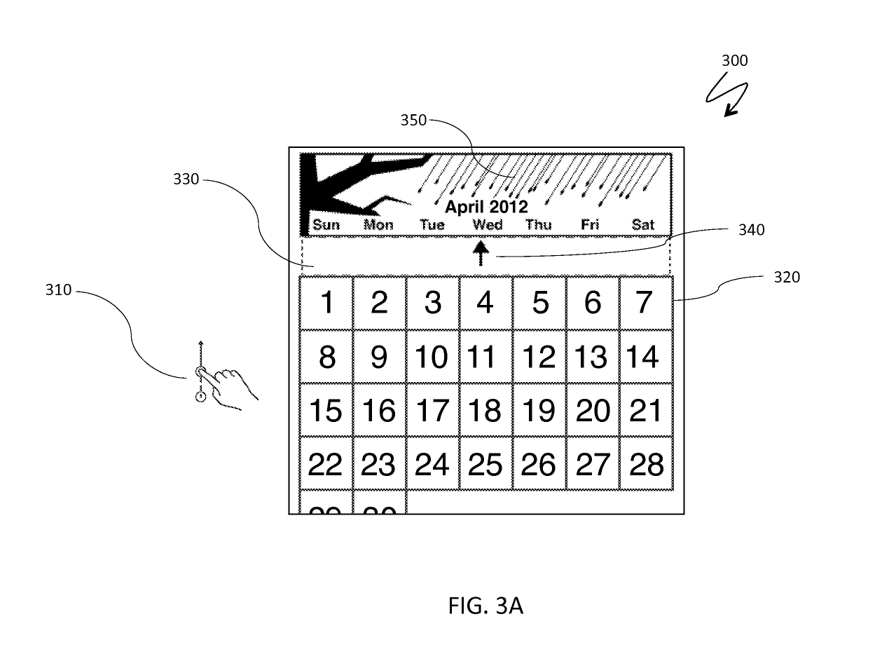

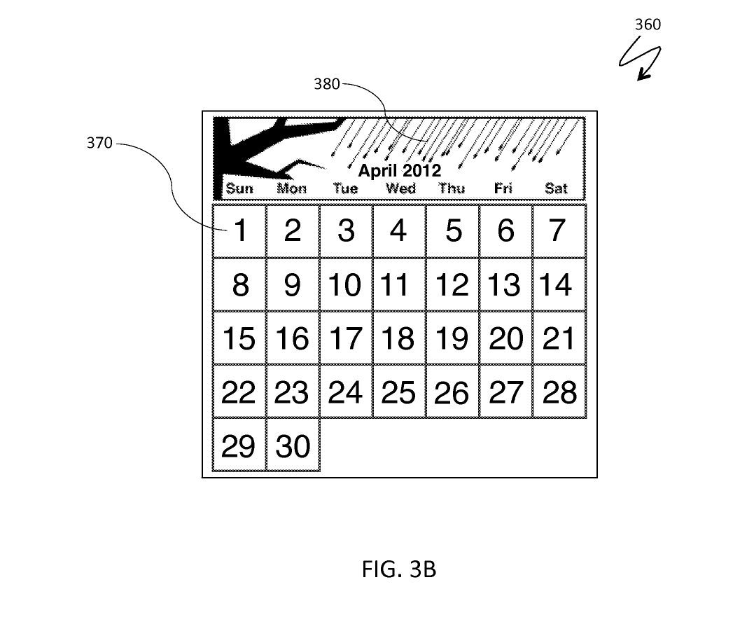

FIG. 3A is a schematic illustration 300 of fast scrolling preceding snapping of a monthly grid 320 to display a one-month calendar view. After a user makes a swipe gesture 310 to fast scroll the monthly grid 320, the grid 320 gradually decelerates and the system calculates a stop time and a stop position 330 of the grid 320. If the stop position 330 of the grid 320 is sufficiently close to the a top position, as illustrated by a gap arrow 340 relative to a monthly banner 350, then the system instructs the grid 320 to snap into a one-month view slot 370 as shown on a schematic illustration 360 of FIG. 3B. Before the grid 320 comes to the full stop due to deceleration, the grid 320 may momentarily accelerate, snap into the one-month view slot 370 right below a monthly banner 380, cover the gap 340 and will stay in the one-month view slot 370 waiting for a user action.

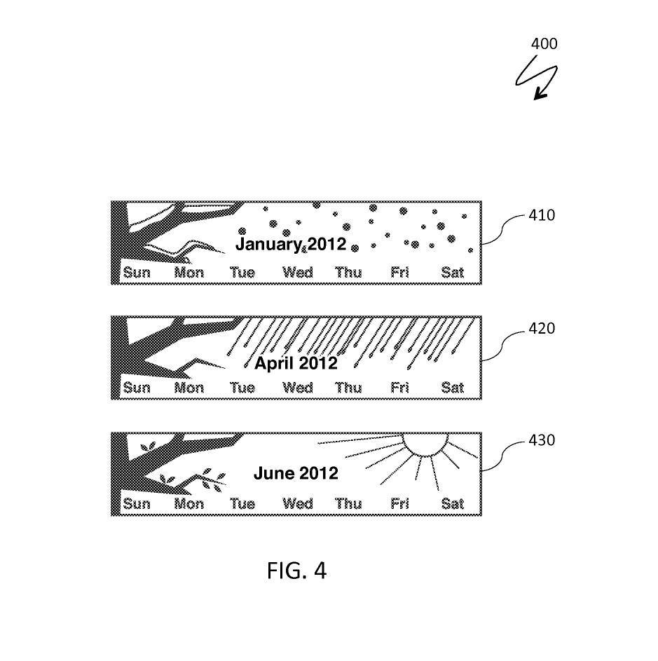

FIG. 4 is a schematic illustration 400 of monthly banners 410, 420, 430 with visual clues implemented in the system. Each of the banners 410, 420, 430 has multiple seasonal clues to employ perception of a user and facilitate a quick choice of a desired month. It should be noted that the banners 410, 420, 430 assume a certain climatic zone; characteristic depictions of months may be different in other zones. In an embodiment, the system is supplied with a stack of customized monthly banners, which are set up when a user indicates regional settings and which may be additionally customized within any software application that uses the system.

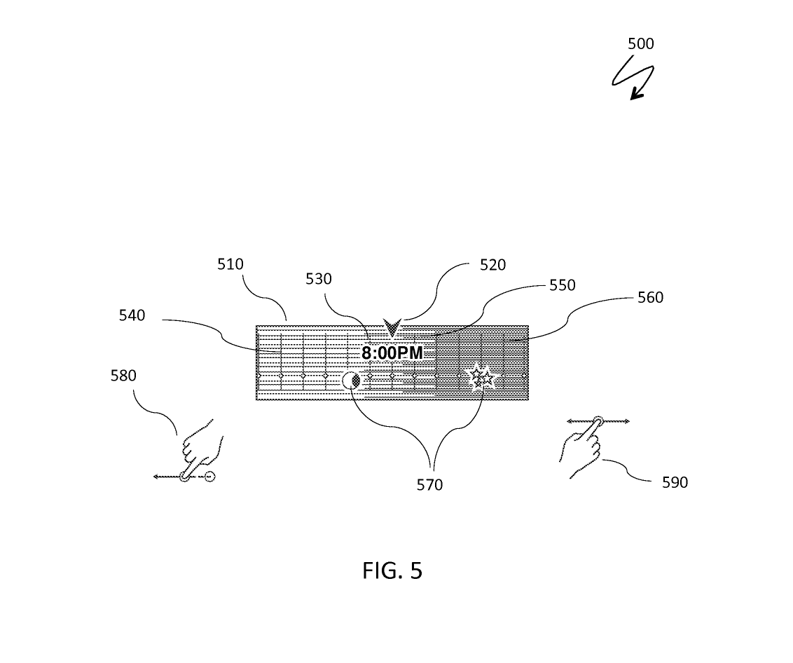

FIG. 5 is a schematic illustration 500 of operations with the time picker. In an embodiment, the time picker is implemented as an endless (circular) time band 510 with a needle 520 centered across a visible portion of the time band 510. A picked time value 530 is constantly changing on the scrolling time band. When the time band 510 is stopped by a user in a desired position, a displayed time value is the one picked by a user (8:00 PM in the example 530). The time band 510 may be split into daytime periods illustrated to the user by visual clues. Three visual clues are shown on FIG. 5: daytime 540 visual clue (light background), an evening visual clue 550 (gradually darkening background) and a nighttime visual clue 560 (dark background). In addition to the background motives, the three periods may be marked by daytime separators 570 (half-moon for the evening and stars for the nighttime).

Operating the time picker is similar to working with the date picker. Two gestures: a swipe 580 and a scroll 590 allow the user to do fast or slow (and controlled) scrolling of the time band in order to position the needed time below the needle. Just as with the date picker, an initial speed of the swipe gesture determines a speed for fast scrolling. A maximum impulse swipe gesture across the time band may scroll through a whole day within approximately two seconds. Stopping the time band midway by touching the screen brings the time picker close to a desired time selection, and an additional slow scrolling for precise positioning may complete the task.

It should be noted that a scrolling directions for the date picker and the time picker may be orthogonal to the screen of a mobile device: the date picker is operated by the vertical, up-down swipe and scroll, while the time is picked via the horizontal, left-right gestures. In addition to a compact design, this feature serves an ergonomic purpose by introducing additional variability into users' muscular activity.

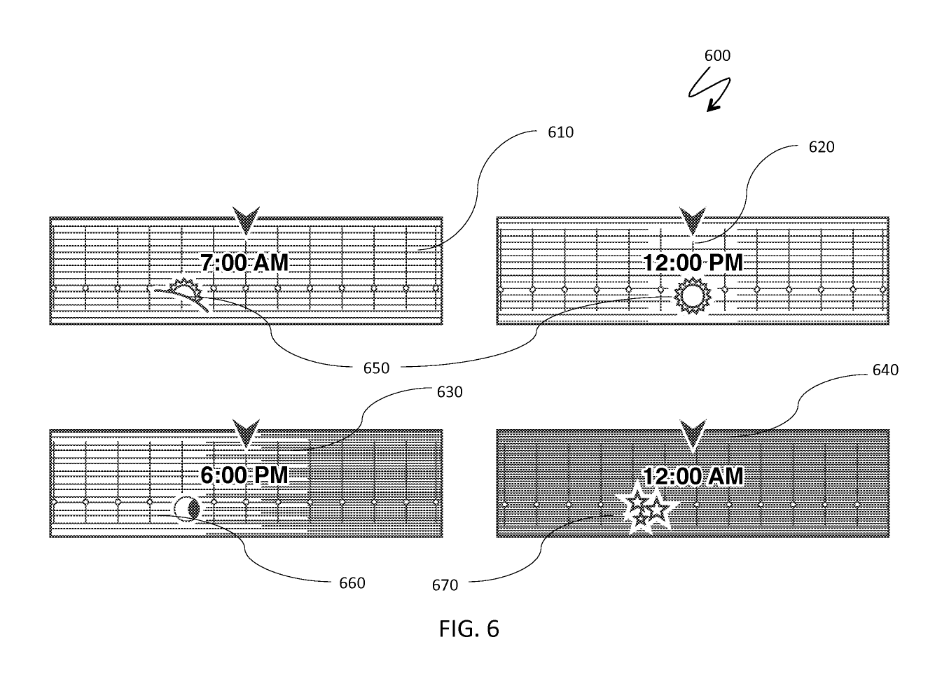

FIG. 6 is a more detailed schematic illustration of the four daytime portions of the time picker with the visual clues. Morning/afternoon portions are characterized by a moderately to intensely bright backgrounds 610, 620, while an evening background 630 is gradually darkening and a nighttime background 640 is uniformly dark. Additionally, two daytime separators 650 for the morning and the afternoon periods are derived from a generic image of sun, while the two other separators, evening 660 and nighttime 670, represent different images. As explained elsewhere herein, the images may be customized to represent different culturally acceptable sets of separators based on a mobile device's regional settings and user preferences.

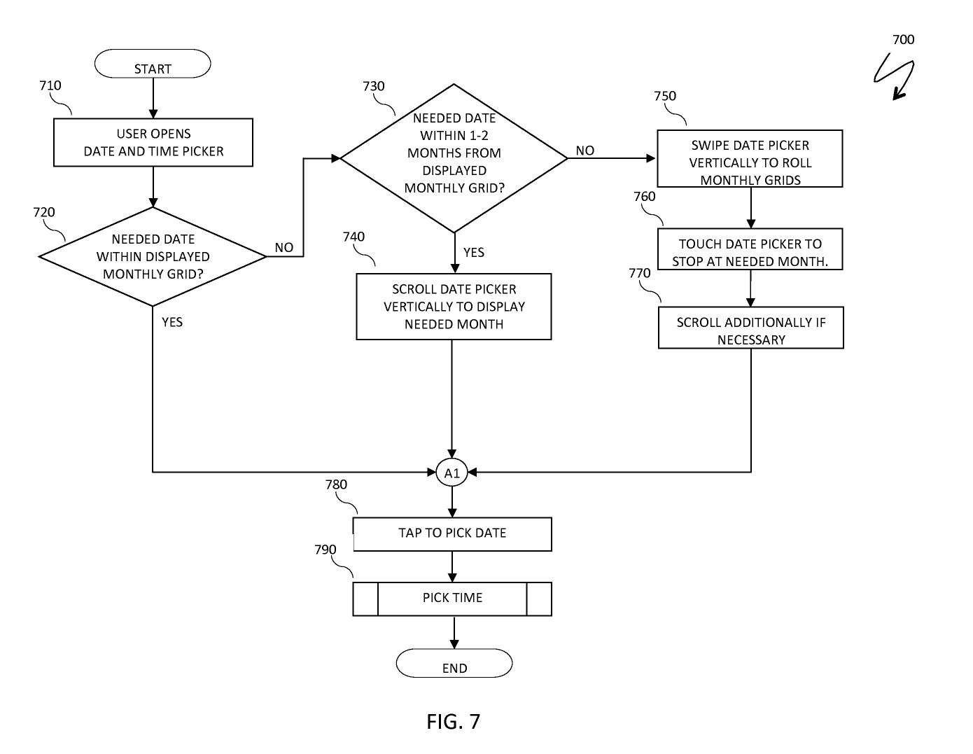

Referring to FIG. 7, a flow diagram 700 describes operation of the date picker. Processing begins at a step 710 where a user opens a date and time picker (the two components are combined on the screen of the mobile device, as explained elsewhere herein). After the step 710, processing proceeds to a test step 720 where it is determined if a needed date is displayed within a visible portion of a currently displayed monthly grid. If so, then processing proceeds to a step 780. Otherwise, processing proceeds to a test step 730 where it is determined if the needed date is within one to two months from the currently displayed monthly grid. If so, then processing proceeds to a step 740; otherwise, processing proceeds to a step 750. At the step 740, a user scrolls the date picker in a controlled scrolling mode (keeping finger(s) in contact with the screen) until a desired month is displayed on the screen.

After the step 740, processing proceeds to a step 780, which is also independently reached from the step 720, as explained elsewhere herein. At the step 750, since the needed month is three or more months away from the current monthly grid, it may be more efficient to use fast scrolling. If so, the user swipes the date picker vertically to automatically roll monthly grids quicker. After the step 750, processing proceeds to a step 760 where the user touches the date picker and stops the date picker once the desired month appears moving across the screen. After the step 760, processing proceeds to a step 770 where the user additionally scrolls the date picker in the event the desired month was missed because of fast changing screen content or for some other reasons. After the step 770, processing proceeds to the step 780, which can be independently reached from the steps 720, 740, as explained elsewhere herein. At the step 780, the user may tap a needed date cell within a desired monthly grid to pick the needed date. After the step 780, processing proceeds to a step 790, where the user picks the time. After the step 790, processing is complete.

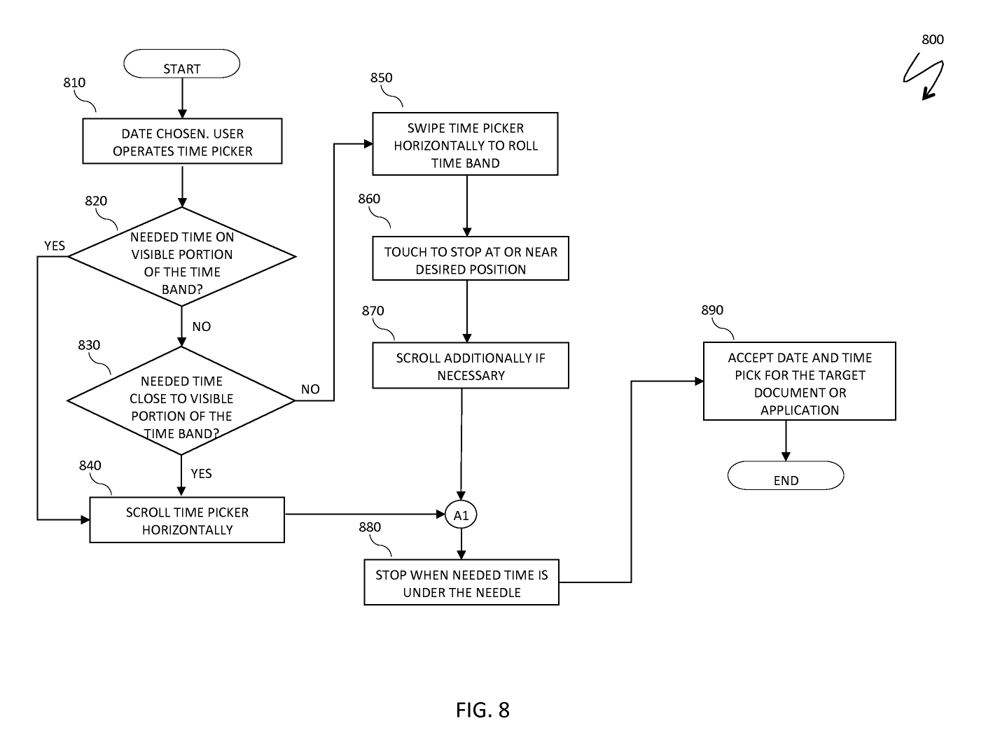

Referring to FIG. 8, a flow diagram 800 illustrates in more detail processing performed at the step 790, discussed above. Processing begins at a step 810 where the user has completed picking the date and switches to the time picker. After the step 810, processing proceeds to a test step 820 where it is determined if a needed time is in the visible portion of the time band. If so, then processing proceeds to a step 840; otherwise, processing proceeds to a test step 830 where it is determined (by the user) if the needed time, although not in the visible portion of the time band, is close to the visible portion. If so, then processing proceeds to the step 840, which may also be independently reached from the step 820; otherwise, processing proceeds to a step 850. At the step 840, the user scrolls the time band horizontally (without lifting finger(s) from the screen, i.e. in the fully controlled way) to position the desired time value under the needle. After the step 840, processing proceeds to a step 880.

At the step 850, the user swipes the time picker horizontally to roll the time band with higher speed, since the location of the desired time may be too far from a currently visible portion to warrant scrolling slowly. After the step 850, processing proceeds to a step 860 where the user touches the fast scrolling time band to stop it at or near the desired position. After the step 860, processing proceeds to a step 870 where the user additionally scrolls the time picker in the event the desired time value has been missed because of the fast scrolling or for other reasons. After the step 870, processing proceeds to the step 880, which can be reached independently from the step 840. At the step 870, the user stops scrolling when the needed time value is positioned under the needle (see, for example, FIGS. 5 and 6). After the step 880, processing proceeds to a step 890 where the user accepts the date and the time pick for use in a target document or application which incorporates date-and-time selection. After the step 890, processing is complete.

Various embodiments discussed herein may be combined with each other in appropriate combinations in connection with the system described herein. Additionally, in some instances, the order of steps in the flowcharts, flow diagrams and/or described flow processing may be modified, where appropriate. Subsequently, elements and areas of screen described in screen layouts may vary from the illustrations presented herein. Further, various aspects of the system described herein may be implemented using software, hardware, a combination of software and hardware and/or other computer-implemented modules or devices having the described features and performing the described functions. The mobile device may be a touch sensitive tablet or a mobile phone, although other devices are also possible.

Software implementations of the system described herein may include executable code that is stored in a computer readable medium and executed by one or more processors. The computer readable medium may be non-transitory and include a computer hard drive, ROM, RAM, flash memory, portable computer storage media such as a CD-ROM, a DVD-ROM, a flash drive, an SD card and/or other drive with, for example, a universal serial bus (USB) interface, and/or any other appropriate tangible or non-transitory computer readable medium or computer memory on which executable code may be stored and executed by a processor. The system described herein may be used in connection with any appropriate operating system.

Other embodiments of the invention will be apparent to those skilled in the art from a consideration of the specification or practice of the invention disclosed herein. It is intended that the specification and examples be considered as exemplary only, with the true scope and spirit of the invention being indicated by the following claims.

What is claimed is:

1. A method of electronically selecting a date and time, comprising:
scrolling a series of panels, each panel corresponding to a number of days grouped together, wherein visually the panels appear to be rotating about a first axis coplanar with a screen of an electronic device;
selecting at least one of the panels;
selecting a day on one of the panels;
scrolling a time band having positions thereon corresponding to a time of day, wherein visually the time band appear to be rotating about a second axis coplanar with a screen of the electronic device; and
selecting a position on the time band corresponding to a particular time by stopping the time band from rotating.

2. A method, according to claim 1, wherein each panel corresponds to a month.

3. A method, according to claim 2, wherein each panel includes a banner having visual clues indicating a corresponding month.

4. A method, according to claim 1, wherein the time band includes visual clues indicating time of day.

5. A method, according to claim 1, wherein selecting a position of the time band corresponding to a particular time includes providing a stationary indicator that points to the particular time.

6. A method, according to claim 1, wherein the first and second axes are substantially orthogonal.

7. A method, according to claim 6, wherein the first axis extends substantially left to right with respect to a user viewing the screen of the electronic device and the second axis extends substantially up and down with respect to a user viewing the screen of the electronic device.

8. A method, according to claim 1, wherein selecting at least one of the panels includes stopping the series of panels from rotating.

9. A method, according to claim 8, wherein following stopping the series of panels, a single panel is presented on the screen.

10. A method, according to claim 8, wherein following stopping the series of panels, an end portion of one panel and a beginning portion of a subsequent panel are presented on the screen.

11. A method, according to claim 1, wherein scrolling the series of panels includes using a swiping gesture in a direction substantially orthogonal to the first axis of rotation, wherein a speed of rotation of the first series of panels varies according to a speed of the swiping gesture.

12. A method, according to claim 11, wherein, following the swiping gesture, rotation of the series of panels decelerates and, at the end of the deceleration, rotation momentarily accelerates to statically present a single one of the panels on the screen.

13. A method, according to claim 1, wherein the electronic device is one of: a tablet and a mobile phone.

14. Computer software, provided in a non-transitory computer-readable medium, that facilitates electronically selecting a date and time, the software comprising:
executable code that, in response to user input, scrolls a series of panels, each panel corresponding to a number of days grouped together, wherein visually the panels appear to be rotating about a first axis coplanar with a screen of an electronic device;
executable code that, in response to user input, scrolls a time band having positions thereon corresponding to a time of day, wherein visually the time band appear to be rotating about a second axis coplanar with a screen of the electronic device; and
executable code that accepts a user selection of a date corresponding to the series of panels and a time corresponding to a position on the time band.

15. Computer software, according to claim 14, wherein each panel corresponds to a month.

16. Computer software, according to claim 15, wherein each panel includes a banner having visual clues indicating a corresponding month.

17. Computer software, according to claim 14, wherein the time band includes visual clues indicating time of day.

18. Computer software, according to claim 14, wherein a stationary indicator is provided that points to the particular time selected by the user.

19. Computer software, according to claim 14, wherein the first and second axes are substantially orthogonal.

20. Computer software, according to claim 19, wherein the first axis extends substantially left to right with respect to a user viewing the screen of the electronic device and the second axis extends substantially up and down with respect to a user viewing the screen of the electronic device.

21. Computer software, according to claim 14, wherein the electronic device is one of: a tablet and a mobile phone.
